(19) United States
(12) Patent Application Publication
(10) Pub. No.: US 2011/0265287 A1
(43) Pub. Date: Nov. 3, 2011

(54) HINGE ASSEMBLY

(75) Inventors: JIAN LI, Shenzhen City (CN); JIN-XIN WANG, Shenzhen City (CN)

(73) Assignees: HON HAI PRECISION INDUSTRY CO., LTD., Tu-Cheng (TW); HONG FU JIN PRECISION INDUSTRY (ShenZhen) Co., LTD, Shenzhen City (CN)

(21) Appl. No.: 12/826,943

(22) Filed: Jun. 30, 2010

(30) Foreign Application Priority Data
Apr. 30, 2010 (CN) 201010160481.4

(51) Int. Cl. E05F 1/08; E05D 11/10

(52) U.S. Cl. 16/297; 16/277

(57) ABSTRACT

A hinge assembly includes a shaft, a fixing bracket, a revolving bracket, a resilient member, and a fastening member. The fixing bracket comprises a contact surface, and is sleeved on the shaft. The revolving bracket comprises a contact surface matching the contact surface of the fixing bracket. The resilient member is sleeved on the shaft. The fastening member is fixed on the shaft. The contact surface of the fixing bracket defines at least two positioning recesses, in one of which a positioning protrusion formed on the contact surface of the revolving bracket is selectively received.

### BACKGROUND

1. Technical Field

The present disclosure relates to a hinge assembly, and particularly to a hinge assembly employed in an electronic device.

2. Description of Related Art

Collapsible electronic devices, such as notebook computers, are popular for their portability. In the collapsible electronic device, a cover is hinged on a main body via a typical conventional hinge assembly.

The typical conventional hinge assembly often includes a shaft, a revolving bracket, a fixing bracket, a friction member, a resilient member, and a fastening member. The revolving bracket, the fixing bracket, the friction member, and the resilient member are sleeved on the shaft. The fastening member is fixed on the shaft. Each of the revolving bracket and the fixing bracket includes a contact surface. One of the contact surfaces forms a protrusion, and the other contact surface defines a slot for receiving the protrusion. In use, the revolving bracket rotates relative to the fixing bracket, the protrusion withdraws from the slot to resist the contact surface and deform the resilient member. Friction force generated between the components of the hinge assembly allow the revolving bracket to maintain the respective desired positions relative to the fixed bracket.

However, with use, the friction force is diminished due to aging of the resilient member.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an exploded, isometric view of one embodiment of a hinge assembly.

FIG. 2 is similar to FIG. 2, but viewed from another aspect

FIG. 3 is an assembled, isometric view of the hinge assembly of FIG. 1.

FIG. 4 is similar to FIG. 3, but shows the hinge assembly in another operating state.

### DETAILED DESCRIPTION

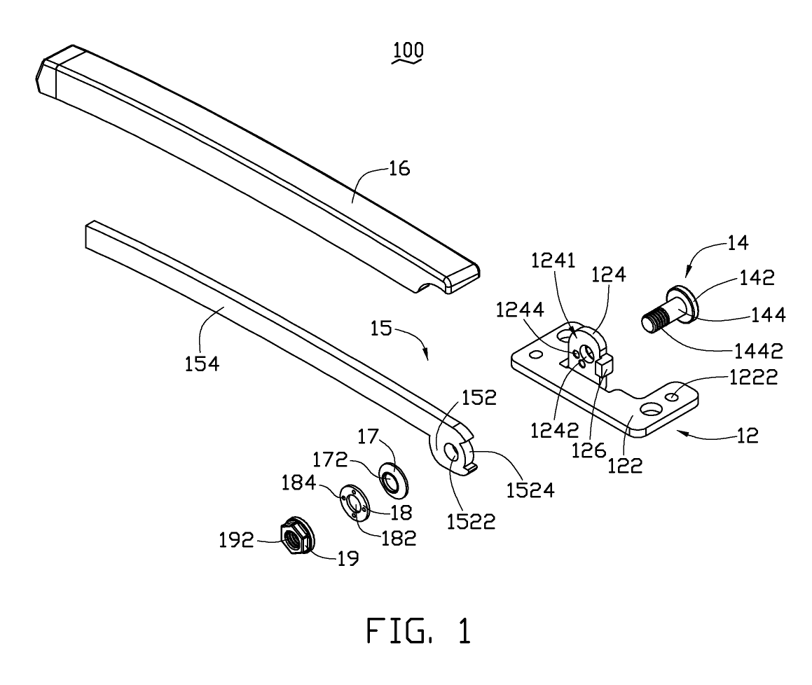

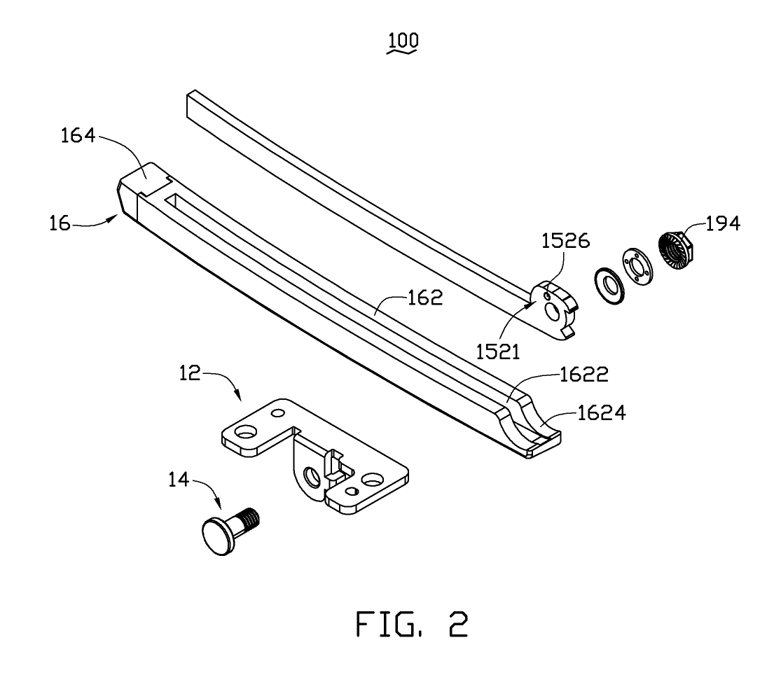

The present hinge assembly may be used in electronic devices, such as notebook computers, person digital assistants, digital photo frames, liquid crystal display monitors, and others. Referring to FIG. 1 and FIG. 2, an embodiment of a hinge assembly 100 includes a fixing bracket 12, a pivot pivot shaft 14, a revolving bracket 15, a protective member 16, a resilient member 17, a washer 18, and a fastening member 19.

The fixing bracket 12 includes a mounting portion 122, a connecting portion 124, and a restricting protrusion 126. The mounting portion 122 and the connecting portion 124 are substantially planar. The mounting portion 122 defines at least one fixing hole 1222. The fixing bracket 12 may be fixed to a surface (not shown) by a fastener (not shown) passing through the fixing hole 1222 and a threaded hole (not shown) of the surface (not shown). The connecting portion 124 extends from the mounting portion 122. An end of the connecting portion 124 away from the mounting portion 122 may be arcuate. The connecting portion 124 includes a contact surface 1241 and a pivot hole 1242. The pivot hole 1242 is a through hole passing through the contact surface 1241 in the center of the connecting portion 124. The connecting portion 124 defines a plurality of positioning recesses 1244 depressed from the contact surface 1241. The positioning recesses 1244 are aligned at a circumference sharing a center of the pivot hole 1242. In the illustrated embodiment, one positioning recess 1244 is adjacent to the mounting portion 122, and another positioning recess 1244 is further away from the mounting portion 122. Each of the positioning recesses 1244 is arcuate. The restricting protrusion 126 extends from a side of the connecting portion 124 and protrudes out of the contact surface 1241.

The pivot shaft 14 includes a cap 142 and a shaft portion 144. The cap 142 is formed at an end of the shaft portion 144 and has a diameter larger than that of the shaft portion 144. The shaft portion 144 further forms a fastener thread 1442 at a free end opposite to the cap 142.

The revolving bracket 15 includes a rotary portion 152 and a swing arm 154 connecting with the rotary portion 152. The rotary portion 152 is substantially disk-shaped and includes a contact surface 1521, a through hole 1522 and a curved restricting slot 1524. The through hole 1522 is defined in the center of the rotary portion 152. The curved restricting slot 1524 is defined around the through hole 1522 away from the swing arm 154, and shares a center with the through hole 1522. In the illustrated embodiment, the contact surface 1521 faces and is matched to the contact surface 1241 of the fixing bracket 12. The rotary portion 152 forms a positioning protrusion 1526 on the contact surface 1521. The positioning protrusion 1526 has a shape corresponding to and is smaller than the positioning recess 1244, such that the positioning protrusion 1526 can be received in the positioning recess 1244. The swing arm 154 extends from the periphery of the rotary portion 152. In the illustrated embodiment, the revolving bracket 15 and the fixing bracket 12 are made of the same or similar material to avoid abrasion thereof when the revolving bracket 15 rotates relative to the fixing bracket 12.

The protective member 16 includes a main body 162 and an engaging portion 164 formed at an end of the main body 162. The main body 162 defines a receiving slot 1622 to receive the swing arm 154. The main body 162 further forms an assisting portion 1624 at an end away from the engaging portion 164. In the illustrated embodiment, the assisting portion 1624 is an arcuate recess defined in the main body 162 and communicates with the receiving slot 1622. The engaging portion 164 is a silicone gasket to prevent abrasion while fixing an electronic device to the protective member 16.

The resilient member 17 may be a substantially disk-shaped elastic member defining a through hole 172. The through hole 172 corresponds in shape and size to a cross section of the shaft portion 144, such that the resilient member 17 may be sleeved on the shaft portion 144.

The washer 18 may be substantially disk-shaped and defines a through hole 182. The through hole 182 corresponds in shape and size to the cross section of the shaft portion 144, such that the washer 18 may be sleeved on the shaft portion 144. The washer 18 further defines several oil holes 184 aligned around the through hole 182.

The fastening member 19 may be a nut defining a threaded hole 192. The fastening member 19 has a friction portion 194 formed at an end. In the illustrated embodiment, the friction portion 194 includes several protrusions protruding from an end surface of the fastening member 19.

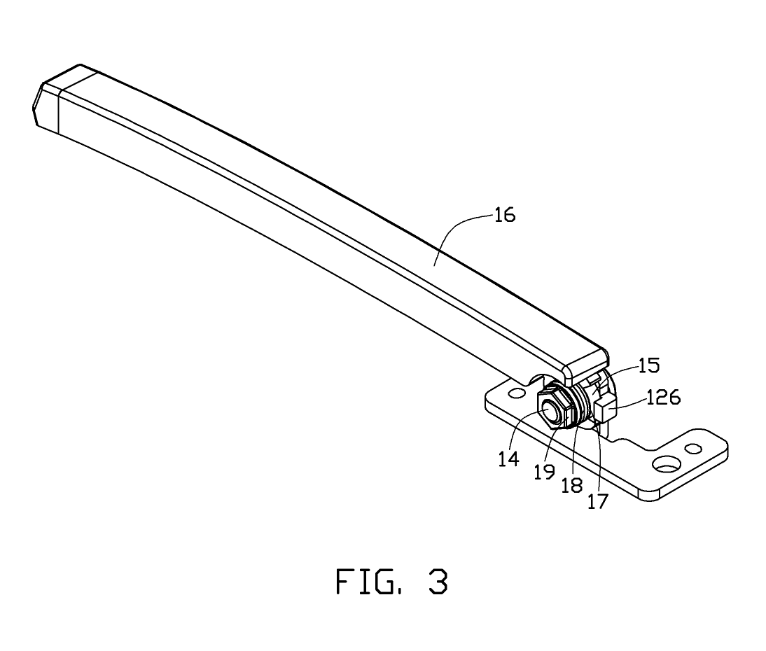

Also referring to FIG. 3, the shaft portion 144 of the pivot shaft 14 passes through the pivot hole 1242 of the fixing bracket 12, the through hole 1522 of the revolving bracket 15, the through hole 172 of the resilient member 17, and the through hole 182 of the washer 18, in that order. The positioning protrusion 1526 is received in the positioning recess 1244 adjacent to the mounting portion 122. The restricting protrusion 126 is received in the curved restricting slot 1524, and a sidewall defines the curved restricting slot 1524 abutting an end of the restricting protrusion 126 adjacent to the mounting portion 122. The fastening member 19 is threaded onto the pivot shaft 14 and resists the washer 18. The swing arm 154 is securely received in the receiving slot 1622, and the assisting portion 1624 corresponds to the rotary portion 152 of the revolving bracket 15.

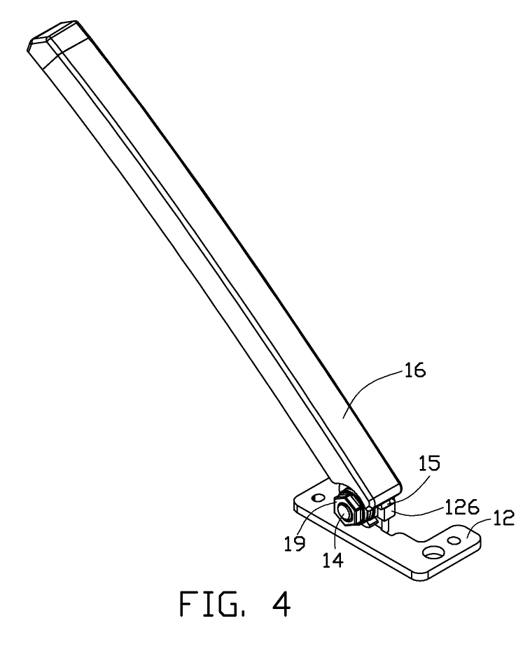

In a first state, the positioning protrusion 1526 is received in the positioning recess 1244 adjacent to the mounting portion 122, and the contact surface 1241 of the fixing bracket 12 abuts the contact surface 1521 of the revolving bracket 15. Referring to FIG. 4, when the revolving bracket 15 rotates relative to the fixing bracket 12, the positioning protrusion 1526 withdraws from the positioning recess 1244 adjacent to the mounting portion 122, and the positioning recess 1244 resists the contact surface 1241 of the fixing bracket 12 and deforms the resilient member 17. An amount of axial force is generated between the components of the hinge assembly 100. When the revolving bracket 15 is rotated further, the positioning protrusion 1526 is received in the positioning recess 1244 away from the mounting portion 122, and an opposite sidewall defining the curved restricting slot 1524 abuts an end of the restricting protrusion 126 away from the mounting portion 122, such that the revolving bracket 15 is prevented from rotating any further and the revolving bracket 15 reaches a maximum opening position, and the hinge assembly 100 is in a second state.

The revolving bracket 15 may achieve a plurality of different opening positions relative to the fixing bracket 12 by receiving the positioning protrusion 1526 in different positioning recesses 1244, thereby avoiding the sliding of the revolving bracket 15 relative to the fixing bracket 12 due to the aging of the resilient member 17.

The revolving bracket 15 and the fixing bracket 12 are the same or similar materials so as to avoid abrasion when the revolving bracket 15 is rotated relative to the fixing bracket 12, such that the service life of the hinge assembly 100 can be prolonged.

Alternatively, the positioning protrusion 1526 may be instead formed on the contact surface 1241 of the fixing bracket 12, and the positioning recesses 1244 defined in the contact surface 1521 of the revolving bracket 15 accordingly.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A hinge assembly comprising:
a pivot shaft;
a fixing bracket comprising a contact surface, and sleeved on the pivot shaft;
a revolving bracket comprising a contact surface matching the contact surface of the fixing bracket, the revolving bracket sleeved on the pivot shaft;
a resilient member sleeved on the pivot shaft; and
a fastening member fixed on the pivot shaft;
wherein the contact surface of the fixing bracket defines at least two positioning recesses, and the contact surface of the revolving bracket forms a positioning protrusion selectively received in one of the positioning recesses.

2. The hinge assembly of claim 1, wherein the fixing bracket further defines a pivot hole, a center of the pivot hole shares a circumference at which the positioning recesses are aligned.

3. The hinge assembly of claim 1, wherein the positioning recess is arcuate, and the positioning protrusion corresponds in shape to and is smaller than the positioning recess.

4. The hinge assembly of claim 1, wherein the fixing bracket further comprises a restricting protrusion protruding out of the contact surface, the revolving bracket defines a curved restricting slot in the contact surface, and the restricting protrusion is received in the curved restricting slot.

5. The hinge assembly of claim 1, wherein the revolving bracket comprises a rotary portion and a swing arm extending therefrom, wherein the rotary portion defines a through hole through which the pivot shaft passes.

6. The hinge assembly of claim 5, further comprising a protective member defining a receiving slot in which the swing arm is securely received.

7. The hinge assembly of claim 6, wherein the protective member comprises a main body and an engaging portion at an end of the main body, the receiving slot defined in the main body, and the engaging portion formed at an end of the main body away from the rotary portion.

8. The hinge assembly of claim 7, wherein the engaging portion is a silicone gasket.

9. The hinge assembly of claim 1, wherein the revolving bracket and the fixing bracket are the same materials.

10. The hinge assembly of claim 1, further comprising a washer positioned between the resilient member and the fastening member.

11. A hinge assembly comprising:
a shaft;
a fixing bracket comprising a contact surface, and sleeved on the shaft;
a revolving bracket comprising a contact surface matching with the contact surface of the fixing bracket, the revolving bracket sleeved on the shaft;
a resilient member sleeved on the shaft; and
a fastening member fixed on the shaft;
wherein the contact surface of the revolving bracket defines at least two positioning recesses, and the contact surface of the fixing bracket forms a positioning protrusion selectively engaging with one of the positioning recesses.

12. The hinge assembly of claim 11, wherein the revolving bracket further defines a through hole, a center of the through hole shares a circumference at which the positioning recesses are aligned.

13. The hinge assembly of claim 11, wherein the positioning recess is arcuate, and the positioning protrusion corresponding in shape to and smaller than the positioning recess.

14. The hinge assembly of claim 11, wherein the fixing bracket further comprises a restricting protrusion protruding out of the contact surface, and the revolving bracket defines a curved restricting slot in the contact surface in which the restricting protrusion is received.

15. The hinge assembly of claim 11, wherein the revolving bracket comprises a rotary portion and a swing arm extending from the rotary portion, the rotary portion defining a through hole through which the shaft passes.

16. The hinge assembly of claim 15, further comprising a protective member defining a receiving slot in which the swing arm is securely received.

17. The hinge assembly of claim 16, wherein the protective member comprises a main body and an engaging portion at an end of the main body, wherein the receiving slot is defined in the main body and the engaging portion is formed at an end of the main body away from the rotary portion.

18. The hinge assembly of claim 17, wherein the engaging portion is a silicone gasket.

19. The hinge assembly of claim 11, wherein the revolving bracket and the fixing bracket are the same materials.

20. The hinge assembly of claim 11, further comprising a washer positioned between the resilient member and the fastening member.
